(19) United States
(12) Patent Application Publication
(10) Pub. No.: US 2026/0339981 A1
(43) Pub. Date: Oct. 29, 2026

(54) METHOD, APPARATUS, DEVICE, AND STORAGE MEDIUM FOR MANAGING INFORMATION OF OBJECT

(71) Applicant: Beijing Youzhuju Network Technology Co., Ltd., Beijing (CN)

(72) Inventors: Jing Lin, Beijing (CN); Shengan Cai, Beijing (CN); Cong Liu, Beijing (CN); Long Ru, Beijing (CN); Shaolong Chen, Beijing (CN); Zheng Peng, Beijing (CN); Hongtao Hu, Beijing (CN); Jiacheng Zhang, Beijing (CN); Wenjing Liu, Beijing (CN); Wenhao Li, Beijing (CN); Junliang Chen, Beijing (CN); Siyi Ye, Beijing (CN); Qinglin Xu, Beijing (CN); Junjun Yao, Beijing (CN); Conghai Yao, Beijing (CN); Duanliang Zhou, Beijing (CN); Chao Wu, Beijing (CN); Qiang Liu, Beijing (CN); Zechun Liu, Beijing (CN); Xin Gao, Beijing (CN); Zhiqiang Lin, Beijing (CN); Jie Wang, Beijing (CN); Songyuan Li, Beijing (CN); Pingping Huang, Beijing (CN); Tianhang Ren, Beijing (CN); Xiang Xiao, Beijing (CN); Xiangrui Yue, Beijing (CN); Tao Li, Beijing (CN)

(21) Appl. No.: 19/486,030

(22) PCT Filed: Aug. 29, 2024
(86) PCT No.: PCT/CN2024/115671

§ 371 Date: Nov. 19, 2025

(30) Foreign Application Priority Data
Aug. 31, 2023 (CN) 202311118661.X

(51) Int. Cl. G06F 16/28

(52) U.S. Cl. CPC G06F 16/285

(57) ABSTRACT

Embodiments of the disclosure provide a method, an apparatus, a device, and a storage medium for managing information of an object. The method includes: displaying, in a task list display interface, a task creation entry of an information production task in response to a creation submission request for creating the information production task, an operation item cell included in the task creation entry including a loading control for task data loading; loading, in response to a trigger on the loading control, a relevant object dataset based on data source information corresponding to the information production task; and performing clustering processing on object data in the object dataset, and generating an initial key information set corresponding to the information production task based on a clustering result of the clustering processing. By using the method, an information set corresponding to the information production task may be simply and effectively generated only by simply creating the information production task, large-scale generation of key information involved in a product object may be realized simply and efficiently, and manpower and time cost input in an information production stage may be better saved.

The present application claims priority of Chinese Patent Application No. 202311118661.X, filed on Aug. 31, 2023, and entitled “METHOD, APPARATUS, DEVICE, AND STORAGE MEDIUM FOR MANAGING INFORMATION OF OBJECT”, which is incorporated herein by reference in its entirety.

### FIELD

Embodiments of the present disclosure relate to the field of computer technologies, and in particular, to a method, an apparatus, a device, and a storage medium for managing information of an object.

### BACKGROUND

In practical applications, certain product objects (such as commodities sold on e-commerce platforms) often face scenarios where different merchants sell a same product object simultaneously. Each of these different merchants has a need to describe and introduce relevant product information for the product object on the e-commerce platform. In order to facilitate different merchants to achieve a unified and accurate product information description for the same product object, and also facilitate consumers to make consumption decisions more quickly among different merchants, standardized object information (key description information) may be created for the product object involved on the e-commerce platform (such as commodities sold).

However, regarding generation of key information for the product object, there are currently the following problems. Limited by the generation method of key information, large-scale production of key information for the product object cannot be achieved at present, and the range of object categories involved in the product object with key description information is also limited.

### SUMMARY

Embodiments of the present disclosure provide a method, an apparatus, a device, and a storage medium for managing information of an object, to achieve large-scale production of key information involved in a product object, and expand the range of object categories of product objects covered by the key information.

In a first aspect, an embodiment of the present disclosure provides a method for managing information of an object. The method includes: displaying, in a task list display interface, a task creation entry of an information production task in response to a creation submission request for creating the information production task, an operation item cell comprised in the task creation entry comprising a loading control for task data loading; loading, in response to a trigger on the loading control, a relevant object dataset based on data source information corresponding to the information production task; and performing clustering processing on object data in the object dataset, and generating an initial key information set corresponding to the information production task based on a clustering result of the clustering processing.

In a second aspect, an embodiment of the present disclosure further provides an apparatus for managing information of an object. The apparatus includes: a first response module configured to display, in a task list display interface, a task creation entry of an information production task in response to a creation submission request for creating the information production task, an operation item cell comprised in the task creation entry comprising a loading control for task data loading; a second response module configured to load, in response to a trigger on the loading control, a relevant object dataset based on data source information corresponding to the information production task; and an information production module configured to perform clustering processing on object data in the object dataset, and generate an initial key information set corresponding to the information production task based on a clustering result of the clustering processing.

In a third aspect, an embodiment of the present disclosure further provides a computer device. The computer device includes: one or more processors; and a storage device configured to store one or more programs. The one or more programs, when executed by the one or more processors, cause the one or more processors to implement the method for managing information of an object provided by any embodiment of the present disclosure.

In a fourth aspect, an embodiment of the present disclosure further provides a computer-readable storage medium having a computer program stored thereon. The computer program, when executed by a processor, implements the method for managing information of an object provided by any embodiment of the present disclosure.

### BRIEF DESCRIPTION OF DRAWINGS

In order to more clearly illustrate the technical solutions of the embodiments of the present disclosure, the following briefly introduces the drawings that need to be used in the description of the embodiments. Obviously, the introduced drawings are only part of the drawings of the embodiments to be described in the present disclosure, rather than all of them. For those of ordinary skill in the art, other drawings may also be obtained from these drawings without paying any creative effort.

FIG. 1 is a schematic flowchart of a method for managing information of an object provided by an embodiment of the present disclosure;

FIG. 2a shows an effect display diagram of a task creation interface adopted when creating an information production task in the method provided in the embodiment;

FIG. 2b shows an effect display diagram of a task list display interface involved in the operation of the method provided in the embodiment;

FIG. 2c shows an interface display diagram of an information cleaning operation interface displayed on the information review platform side when performing information cleaning in the method provided in the embodiment;

FIG. 3 is a schematic structural diagram of an apparatus for managing information of an object provided by an embodiment of the present disclosure; and FIG. 4 is a schematic structural diagram of a computer device provided by an embodiment of the present disclosure.

### DETAILED DESCRIPTION

Embodiments of the present disclosure will be described in more detail below with reference to the drawings. Although some embodiments of the present disclosure are shown in the drawings, it should be understood that the present disclosure may be implemented in various forms, and should not be construed as limited to the embodiments set forth herein. On the contrary, these embodiments are provided for a more thorough and complete understanding of the present disclosure. It should be understood that the drawings and embodiments of the present disclosure are only used for illustrative purposes, rather than limiting the protection scope of the present disclosure.

It should be understood that the various steps described in the method implementations of the present disclosure may be performed in different orders, and/or performed in parallel. Furthermore, the method implementations may include additional steps and/or omit the execution of the steps shown. The scope of the present disclosure is not limited in this regard.

The term “include/comprise” and its variants used herein are open-ended inclusions, that is, “include/comprise but not limited to”. The term “based on” is “at least partially based on”. The term “one embodiment” means “at least one embodiment”; the term “another embodiment” means “at least one other embodiment”; the term “some embodiments” means “at least some embodiments”. Relevant definitions of other terms will be given in the following description.

It should be noted that concepts such as “first” and “second” mentioned in the present disclosure are only used to distinguish different apparatuses, modules or units, and are not used to limit the sequence of functions performed by these apparatuses, modules or units, or their interdependence. It should be noted that the modifications of “one” and “multiple” mentioned in the present disclosure are illustrative rather than restrictive, and those skilled in the art should understand that unless clearly indicated in the context, they should be understood as “one or more”.

The names of messages or information exchanged between multiple apparatuses in the implementations of the present disclosure are only used for illustrative purposes, and are not used to limit the scope of these messages or information.

The names of messages or information exchanged between multiple apparatuses in the implementations of the present disclosure are only used for illustrative purposes, and are not used to limit the scope of these messages or information.

It may be understood that before using the technical solutions disclosed in the embodiments of the present disclosure, the user should be informed of the type, range of use, use scenarios, etc. of personal information involved in the present disclosure and obtain the authorization of the user in an appropriate manner according to relevant laws and regulations.

For example, in response to receiving an active request from a user, sending prompt information to the user to clearly prompt the user that the requested operation will need to access and use personal information of the user. As such, the user may independently choose, according to the prompt information, whether to provide the personal information to software or hardware, such as an electronic device, an application, a server or a storage medium, that perform the operations of the technical solutions of the present disclosure.

As an optional but non-limiting implementation, in response to receiving the active request from the user, the manner of sending the prompt information to the user may be, for example, in a manner of a pop-up window, and the prompt information may be displayed in text in the pop-up window. In addition, the pop-up window may further carry a selection control for the user to select “agree” or “disagree” to provide the personal information to the electronic device.

It may be understood that the above process of notifying and obtaining user authorization is only illustrative, and does not limit the implementations of the present disclosure, and other manners that meet relevant laws and regulations may also be applied to the implementations of the present disclosure.

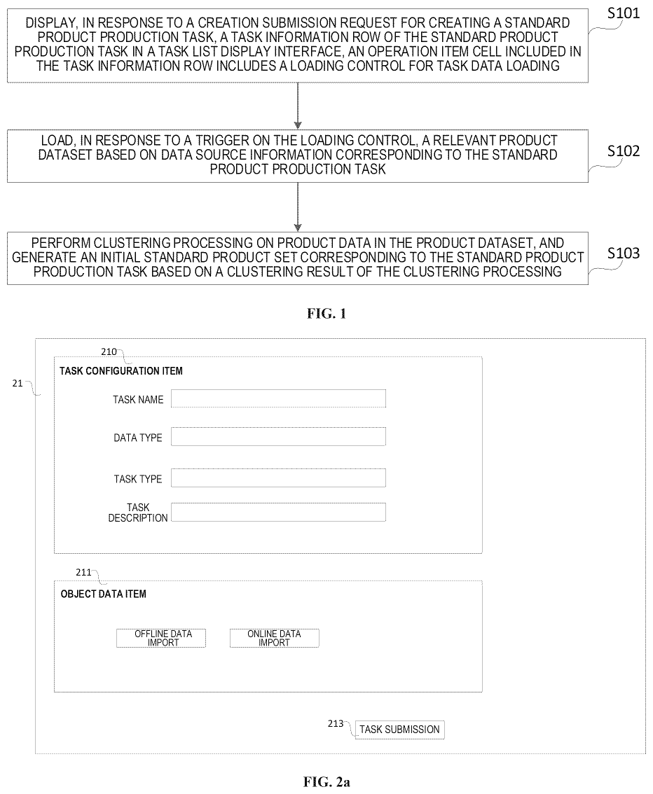

FIG. 1 is a schematic flowchart of a method for managing information of an object according to an embodiment of the present disclosure. The embodiment may be applied to the case of managing key information involved in a product object. The method may be performed by an apparatus for managing information of an object. The apparatus may be implemented by software and/or hardware, and may be configured in a terminal and/or a server to implement the method for managing information of an object in the embodiment of the present disclosure.

It should be noted that an application scenario of the embodiment may be described as follows. On an e-commerce platform that aggregates a large number of product objects, there is a need to have a unified object information description for the same product object. Such unified object information description for the product object may be considered as a key object information description for the product object, and the key object information may be simply referred to as key information. At present, producing key information for the product object has become a trend. However, as the number and variety of product objects included in the e-commerce platform are increasing, if key information is produced solely by manually collecting object description information, the cost input and production efficiency cannot meet the growing demand for key information production. This greatly limits the range of product object categories involved in key information production, and cannot quickly increase the number of associated product objects that use key information for product object description.

The technical solutions of the embodiments of the present disclosure specifically disclose a method and an apparatus for managing information of an object, a device, and a storage medium. The method includes: displaying, in a task list display interface, a task creation entry of an information production task in response to a creation submission request for creating the information production task, an operation item cell comprised in the task creation entry comprising a loading control for task data loading; loading, in response to a trigger on the loading control, a relevant object dataset based on data source information corresponding to the information production task; and performing clustering processing on object data in the object dataset, and generating an initial key information set corresponding to the information production task based on a clustering result of the clustering processing. With the above technical solutions, when there is a need for key information production, the information production task may be first created, and task information of the created information production task may be displayed, in the task list display interface, in the form of entries. The displayed task information entry may correspond to the operation item cell, which may include an operation control that triggers the information production task to respond to relevant execution logic. After responding to the trigger of the loading control corresponding to the information production task, the information production logic of the information production task may be executed, and finally the initial key information set corresponding to the information production task may be obtained. With the above technical solutions of the embodiment, a key information set corresponding to the information production task may be simply and effectively generated by only simply creating the information production task, and the key information set may include a certain scale of key information. Compared with the prior art, the technical solution may provide a production way for large-scale information production, which may simply and efficiently achieve large-scale generation of key information of product objects. It may better save manpower and time cost input in the production stage of key information of product objects, and better improve the production efficiency of key information of product objects.

The method for managing information of an object provided in the embodiment may effectively solve problems existing in current key information production. Specifically, as shown in FIG. 1, the method for managing information of an object provided in the embodiment may include the following steps.

At block S101, in response to a creation submission request for creating an information production task, a task creation entry of the information production task is displayed in a task list display interface, an operation item cell included in the task creation entry includes a loading control for task data loading.

In the embodiment, the provided method for information management may be performed by a pre-built execution platform, which may be an information management operable platform. Therefore, in the embodiment, the key information of the product object may be produced by the information management operable platform. It should be noted that the product object in the embodiment may preferably be an object involved in online shopping in the e-commerce platform scenario. However, the product object in the embodiment is not limited to applications in the e-commerce platform scenario, it may be any application scenario with a need for key information production.

Specifically, in the embodiment, the information management operable platform, which is an execution platform of the provided method, may be provided with an information production function item for achieving key information production. The information production function item may display a relevant function interface, which may be the task list display interface. In the task list display interface, task information of the created information production task may be displayed in the form of task list, and the task information involved in each information production task may be displayed as the entry in the task list, serving as the task information entry of the information production task.

The task list may be considered as a summary table of task information that displays task information entries of the created information production tasks according to predetermined column attribute items. Each task information entry in the task list may correspond to a created information production task. The task information in the task information entry may be formed based on creation information configured in a creation stage of the information production task, and may include information such as the task name and the task type configured for the created task in the creation stage.

In the embodiment, the task information entry included in the task list displayed in the task list display interface may need to be pre-implemented by creating the information production task. Regarding the creation of the information production task, an implementation manner may be described as follows. The task list display interface may display a task creation control, and the task creation interface may be popped up by triggering the task creation control. In the task creation interface, relevant creation information may be configured for the information production task to be created, such as the task name of the created information production task, the data type that identifies data involved in production, etc. It may further configure whether to establish an association relationship with commodities after information production for the created task.

Continuing with the above description, in the popped-up task creation interface, an import path or an upload path of object data involved in information production may be provided, so as to obtain the involved object data when performing information production. In some embodiments, the import path or the upload path may correspond to a local offline storage path of the object data, or an online storage path of the object data. In the embodiment, the configured data path may be regarded as the data source information.

In addition, the task creation interface may further display a creation submission control for submitting the created task. After completing information configuration of various items to be created involved in the information production task, the creation submission control may be triggered. In the embodiment, the creation submission request generated by triggering the creation submission control may be received, and the creation submission request may be responded to through this step.

It may be known that the process of generating the creation submission request based on the trigger on the creation submission control may be similar to the process of summarizing task information edited or configured in the task creation interface. This process may be considered as a summary of task creation information such as a task name, a task type, a data type, and whether an association task is constructed, which are configured for the created information production task. In the embodiment, this step may be used to respond to the creation submission request, and obtain task creation information corresponding to the creation submission request, and then form the task information entry of the created information production task based on the obtained task creation information.

In the embodiment, the column attribute items set by the task list may include an operation attribute item, which may specifically be used to provide an operation control required for an operation for the created information production task. The operation controls involved in different information production tasks may be respectively displayed in operation item cells of corresponding task information entries. For example, for a newly created information production task, the operation item cell of the task information entry corresponding to the newly created information production task may include the loading control, and the loading control, when triggered, may be configured to load object data required for information production.

It should be noted that the operation item cells of different task information entries in the task list may include several fixed universal operation controls. For example, the operation item cell of each task information entry may include a view details control, a close task control, and an edit task control. In addition, the operation item cell may further include an operation control to enter a next production state according to a production state of the corresponding information production task. For example, for the newly created information production task, its initial production state may be “task creation completed”. After the task creation is completed, the next production state to be entered may be a data loading state of the object data required for information production. Therefore, when the information production task is in the “task creation completed” state, the operation item cell of the corresponding task information entry may display the loading control required to enter the next production state (data loading).

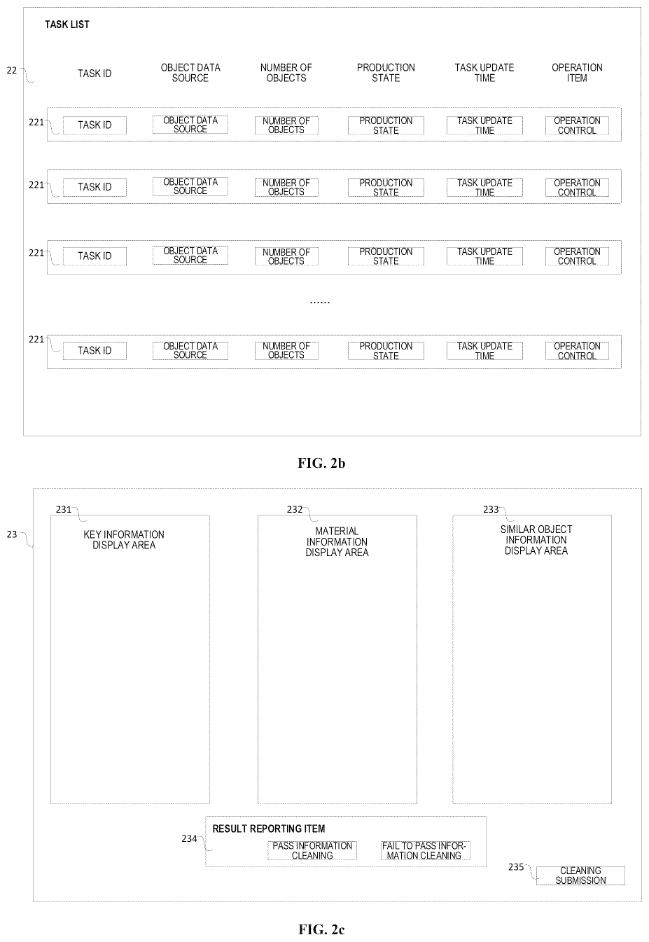

For better understand the creation of the information production task and their display in the task list display interface during the execution of the method provided in the embodiment, this embodiment provides a display of schematic diagrams of effects involved. Specifically, FIG. 2a shows an effect display diagram of the task creation interface used when creating an information production task in the method provided in the embodiment. As shown in FIG. 2a, the displayed task creation interface 21 includes a task configuration item 210, which may be configured to edit information of editable items such as the task name, the task type, the data type, and the task description. The displayed task creation interface 21 further includes an object data item 211, which provides a configuration operation area for configuring a data path of the object data on which information production depends. In practical applications, the task creation interface 21 may further include a configuration operation area (not shown in FIG. 2a) for configuring whether to establish an association relationship, and a task submission control 212 for submitting the created task.

It may be known that after the information production task is created and configured through the task creation interface provided in FIG. 2a and the creation submission request is generated in response to the trigger of the task submission control, the creation submission request may be responded to through this step, and then the task information entry may be formed for the created information production task, and the task information entry may be displayed in the task list of the task list display interface.

FIG. 2b shows an effect display diagram of a task list display interface involved in the operation of the method provided in the embodiment. As shown in FIG. 2b, the displayed task list display interface 22 includes a task list. The task list displays task information entries 221 corresponding to different created information production tasks, and column attribute items that may be displayed in the task information entries 221 include a task ID, an object data source, the number of objects, the production state, the task update time, and an operation item cell. In some embodiments, the operation item cell may include universal controls such as the view details control, the close task control, the edit task control, and the operation control that is triggered by the production state to enter the next production state.

At block S102, in response to a trigger on the loading control, a relevant object dataset is loaded based on data source information corresponding to the information production task.

In the embodiment, after the loading control displayed in the operation item cell is triggered, the trigger of the loading control may be generated. This step may respond to the trigger of the loading control, and control the corresponding information production task to enter the data loading state. It should be note that in the data loading state, the information production task involves not only the simple loading of the object data, but also the generation of a key information set for the information production task based on the loaded object data. In the embodiment, the key information set may be referred to as the initial key information set. Based on the above description, this embodiment may respond to the trigger involved in the loading control through this step and the following step S103.

Specifically, firstly, the object data required for the information production task to perform information production may be loaded through this step. In some embodiments, the data source information may be data path information configured in the creation stage of the information production task, and the relevant object data may be obtained through a specific data path in the data source information. In the embodiment, in order to achieve large-scale production of key information, a certain amount of object data may often be relied on, and the certain amount of object data obtained by loading may be referred to as the object dataset.

At block S103, clustering processing is performed on object data in the object dataset, and an initial key information set corresponding to the information production task is generated based on a clustering result of the clustering processing.

In the embodiment, after the object dataset is loaded through the above steps, the clustering processing may be performed on the object data in the object dataset through this step. The clustering processing of the object data may be realized through a clustering algorithm, and the clustering result after the clustering processing may be at least one object cluster formed after a clustering condition is satisfied. In some embodiments, the clustering condition may include clustering either based on the same product object, or belonging to the same product category. In the embodiment, the same product object may be preferably used for clustering, and the object data in the object cluster may be considered as similar object data of the same product object, which may also be referred to as intra-cluster object data in the embodiment.

Continuing with the above description, after obtaining the clustering result including at least one object cluster, this step may perform data analysis on the intra-cluster object data in each object cluster, so as to generate a piece of key data for each object cluster. In the embodiment, a piece of key data may be regarded as a piece of key information. That is, through this step, a piece of key information may be generated for each object cluster included in the clustering result. It may be known that in the embodiment, the amount of data of key information initially generated for the created information production task may be the same as the number of clusters of the object clusters included in the clustering result. In the embodiment, the generated key information may be referred to as initial key information, and all initial key information may be summarized to form the initial key information set of the information production task.

In the embodiment, certain data attribute items may be selected as key information attribute items that constitute key information. The selected key information attribute items may further be included in the data attribute items possessed by the object data. In the embodiment, the key information corresponding to the object cluster may be obtained by analyzing the intra-cluster object data in each object cluster in the clustering result.

An implementation of data analysis may be described as follows. For each object cluster, attribute values of each piece of intra-cluster object data included in the object cluster for each selected key information attribute item may be obtained, and then the key attribute value may be determined through the analysis of each attribute value involved in the key information attribute item, the determined key attribute value may be used as a standard product attribute value of the corresponding key information attribute item, and finally, a piece of key information may be formed based on the standard product attribute value of each key information attribute item.

With the method for managing information of an object provided in the embodiment, when there is a need for key information production, the information production task may be first created, and task information of the created information production task may be displayed, in the task list display interface, in a form of entries. The displayed task information entry may correspond to the operation item cell, which may include an operation control that triggers the information production task to respond to relevant execution logic. After responding to the trigger of the loading control corresponding to the information production task, the information production logic of the information production task may be executed, and finally the initial key information set corresponding to the information production task may be obtained. With the above technical solutions of the embodiment, the key information set corresponding to the information production task may be simply and effectively generated by only simply creating the information production task, and the key information set may include a certain scale of key information. Compared with the prior art, the technical solution may provide a production way for large-scale information production, which may simply and efficiently achieve large-scale generation of key information of product objects. It may better save manpower and time cost input in the production stage of key information of product objects, and better improve the production efficiency of key information of product objects.

As a first optional embodiment of this embodiment, on the basis of the above optimizations, performing clustering processing on the object data in the object dataset, and generating the initial key information set corresponding to the information production task based on the clustering result of the clustering processing may further include the following steps.
a1) the clustering result corresponding to the information production task may be obtained by performing clustering processing on the object data in the object dataset using a predetermined object similarity-matching model, where the clustering result includes at least one object cluster, an object cluster includes intra-cluster object data, and the intra-cluster object data shares the same configured attribute in the object dataset.

In the embodiment, when the clustering processing is performed on the object data in the object dataset, the set clustering condition may be to ensure that each object cluster formed after clustering includes object data of product objects with the same configured attribute. The configured attribute may be specifically the same product object. The object similarity-matching model may be regarded as a processing model for performing similarity-matching division on the object data, and it may be considered that after the object data is input to the object similarity-matching model, it may be determined which object data is the object data of the same product object.

Continuing with the above description, the object data in the object dataset may be input to the object similarity-matching model, and at least one output similar object data list may be obtained. Then, different similar object data lists may be merged according to a configured merging condition. Finally, when the number of merged lists of similar object data remains unchanged, similar object data included in each similar object data list may be regarded as one object cluster, thereby obtaining the clustering result including at least one object cluster.
b1) the initial key information set corresponding to the information production task may be generated based on respective object clusters.

In the embodiment, key attribute items involved in obtaining the key information may be obtained. In an object cluster, attribute values for respective key attribute items may be extracted from respective data attribute values of the included similar object data. By analyzing and comparing the respective attribute values corresponding to each key attribute item, a key attribute value may be determined for each key attribute item. A piece of key information of the relevant object cluster may be formed based on the key attribute value of each key information item, which may be recorded as the initial key information in the embodiment. Finally, all initial key information may be summarized to form the initial key information set of the information production task.

The above technical solution provides an implementation of determining the initial key information set. In this implementation, the determination of the key information may be achieved by finding similar objects in the object data and performing clustering based on the similar data. This implementation achieves classification of object data information by considering data attribute similarity between similar product objects, and the key information formed in this way may better achieve unified information content description of the same product object. Moreover, this implementation mainly involves data information analysis, without manual participation, which better improves the production efficiency of key information.

In the first optional embodiment, an implementation of obtaining the clustering result corresponding to the information production task by performing clustering processing on the object data in the object dataset using a predetermined object similarity-matching model may be further optimized, which may include the following steps.
a11) a plurality of pieces of object data may be selected from the object dataset as reference object data for similarity-matching.

In the embodiment, with reference to the implementation idea of clustering processing, the reference object data for object data clustering may be first selected from the object data in the object dataset. The object data clustering may be achieved by performing similarity-matching operations. The embodiment does not limit the number of reference objects in the selected reference object data. In order to ensure the accuracy of the clustering result, in the embodiment, each piece of object data in the object dataset may be preferably used as the reference object data respectively.
a12) based on the predetermined object similarity-matching model, similar object data in the object dataset matching the reference object data may be obtained, and a plurality of similar object datasets each including the reference object data and corresponding similar object data may be obtained.

It should be noted that the reference object data selected above may serve as data in similarity matching when searching for similar objects in the object data. That is, in an implementation of similarity matching, it is necessary to determine, from the object data in the object dataset, similar object data belonging to the same category of product object as the reference object data.

In the embodiment, for each piece of the reference object data, the similar object data belonging to the similar category may be searched from the object dataset through the object similarity-matching model. In some embodiments, the object similarity-matching model may be a pre-constructed and trained network model, or may be a data classification model trained with samples. In the embodiment, the trained object similarity-matching model may be adopted.

In the embodiment, data information of relevant attribute items of the reference object data may be input to the object similarity-matching model, and then the object data to be matched may also be input to the object similarity-matching model. For the object data, a matching result indicating whether the object data is the similar object data as the reference object data may be output. In this step, a similar object data list may be obtained for each reference object data, and the reference object data and the similar object data in the similar object data list may form a similar object dataset.

Through this step, a similar object datasets equal in number to the number of seeds of the reference object data may be obtained.
a13) the clustering result corresponding to the information production task may be determined based on the plurality of similar object datasets.

It should be noted that, considering that when the reference object data is selected, there are already similar object data among the selected reference object data, therefore, there may be same similar object data in similar object datasets formed for different reference object data. That is, there is still a possibility of re-merging different similar object datasets.

In the embodiment, after a certain number of similar object datasets are obtained, through this step, different similar object datasets may be merged in an appropriate merging way to form a new similar object dataset. The merging process may be repeated until the number of remaining similar object datasets does not change. In this step, the clustering result may be formed based on the remaining similar object datasets after the merging process is completed.

A merging way used for dataset merging may include comparing the similar object data in two similar object datasets respectively. If the proportion of identical object data included in the two similar object datasets reaches a configured threshold, it may be considered that the two similar object datasets satisfies the merging condition, and needs to be merged.

Continuing with the above description, after the number of similar object datasets does not change, each remaining similar object dataset may be regarded as an object cluster, and similar object data included in the similar object dataset may be regarded as the intra-cluster object data in the object cluster. In the embodiment, the obtained object cluster may be regarded as the clustering result of the clustering processing.

The above specific implementation of the clustering result may serve as data support for determining key information, thereby ensuring the efficiency of determining large-scale key information.

As an implementation, determining the clustering result corresponding to the information production task based on the plurality of similar object datasets may include the followings.
a131) an object overlap degree between two similar object datasets in the plurality of similar object datasets may be determined, and a new similar object dataset may be obtained by merging the two similar object datasets in response to the object overlap degree satisfying a merging condition.

In the embodiment, two similar object datasets may be arbitrarily selected from the plurality of similar object datasets, and then a commodity overlap degree between the similar object data in the selected two similar object datasets may be calculated. The commodity overlap degree may be determined by the number of identical objects of identical object data included in the two similar object datasets. For example, the commodity overlap degree may be the ratio of the number of identical objects to the total number of objects included in the two similar object datasets.

In the embodiment, an implementation where the commodity overlap degree satisfying the merging condition may include that the ratio of the number of identical objects to the total number of objects included in the two similar object datasets is greater than or equal to a predetermined proportion threshold. In this step, when the merging condition is satisfied, the similar object data in the two similar object datasets may be merged into a dataset, forming a new similar object dataset.
a132) operations of determining the object overlap degree and merging the two similar object datasets may be repeatedly performed until the number of the new similar object datasets remains unchanged.

In the embodiment, after each merging operation on the similar object datasets, the number of datasets in the similar object datasets may be counted. If the number of datasets in the latest count remains unchanged compared to the number of datasets in the previous count, it may be considered that a termination condition of repeated execution of the execution logic is reached. Otherwise, it is necessary to return to the step a131) to re-perform the operations of determining the commodity overlap degree and merging the similar object datasets.
a133) for the information production task, the clustering result including respective object clusters may be obtained by using each similar object dataset obtained from the repeated operations as an object cluster, where the similar object data included in the object cluster is recorded as intra-cluster object data.

In the embodiment, after the above steps satisfy the termination condition of repeated execution, through this step, each remaining similar object dataset may be used as an object cluster. The clustering result may include all object clusters, and the similar object data included in each object cluster may be recorded as the intra-cluster object data.

The above technical solution provides a specific implementation of the clustering result, which provides effective underlying logic support for the determination of the clustering result.

In the first optional embodiment, generating the initial key information set corresponding to the information production task based on respective object clusters may further include the following steps.
b11) for an object cluster in the clustering result, the intra-cluster object data included in the object cluster may be obtained.

In the embodiment, step b11) and the following step b12) may be considered as processing for determining the key attribute value for each object cluster. For the object cluster for which the key attribute needs to be determined, the intra-cluster object data included in the object cluster may be determined through this step.
b12) a key attribute value of a data attribute item may be determined based on attribute values of respective data attribute items included in the intra-cluster object data.

In the embodiment, it may be considered that data information of the object data may be included by attribute values of different data attribute items. For each intra-cluster object data, their attribute values for the same data attribute item may be same or different. In the embodiment, a mode may be selected from a plurality of attribute values of the data attribute item, and the mode data value may be used as the key attribute value of the data attribute item.

Through the above description, a key attribute value may be determined for each of the data attribute items in the intra-cluster object data.
b13) the initial key information of the object cluster may be determined based on respective key attribute values, and the initial key information set corresponding to the information production task may be determined based on the initial key information of respective object clusters.

In the embodiment, it may be considered that the key attribute items that constitute the key information are derived from the data attribute items included in the object data, and the key information attribute items may be all or part of data attribute items of the object data. For an object cluster, after the key attribute value of each data attribute item is determined through the intra-cluster object data included in the object cluster, the initial key information of the object cluster may be directly formed based on the key attribute value of each data attribute item. Alternatively, the initial key information of the object cluster may be formed based on key attribute values of some of the key information attribute items.

According to the implementation solution of the initial key information set provided in the first optional embodiment, no manual participation is required, and the production efficiency of key information may be better improved.

As a second optional embodiment of the embodiment, on the basis of the above embodiment, optimization steps of the method may be further added.

It should be noted that the method steps added in the second optional embodiment may be considered to be executed after the initial key information set is determined for the information production task. In an application scenario, the initial key information included in the initial key information set may already be stored in the key information database for storing key information. For each information production task, the ultimate goal is that the key information generated for the information production task may be accurate, effective, and stored in the key information database for storage.

In order to achieve the above goal, in the embodiment, the first round of deduplication filtering may be performed on the initial key information in the initial key information set through the following steps. Specifically, the deduplication filtering may include the following steps.
a2) a pre-built key information database may be accessed and initial key information in the initial key information set already stored in the key information database may be recorded as first key information.

In the embodiment, through this step, the initial key information in the initial key information set may be compared with the key information that already stored in the key information database. If there is initial key information that is the same as the stored key information, it may be considered that the initial key information has already stored in the key information database. In this step, the initial key information already stored in the key information database may be recorded as the first key information.
b2) a first key information set of the information production task may be obtained based on remaining initial key information after filtering out the first key information.

In the embodiment, the first key information determined above may be filtered out from the initial key information set, and the remaining initial key information may be recorded as the first key information set of the information production task.

According to the above technical solutions of the second optional embodiment of the embodiment, the deduplication process for the initial key information in the initial key information set may be achieved. In practical applications, the initial key information may not be directly stored the key information database, and further data processing may be required. In the embodiment, through the above steps, key information already stored in the key information database may be filtered out first, so as to reduce the data scale of data to be processed in further subsequent data processing, and better reduce resource occupancy in subsequent processing logic relevant to standard products.

As a third optional embodiment of the embodiment, on the basis of the above second optional embodiment, optimization steps of the method may be further added.

Based on the above description, before performing the storage operation of the initial key information corresponding to the information production task into the key information database, in addition to filtering out key information already stored in the database, subsequent processing may need to be continued for the remaining initial key information that has not been stored. In the third optional embodiment, information cleaning processing and information quality inspection processing may be performed on the first key information set obtained after deduplication through the method step added by the following optimization. Specifically, the added method step may include the following steps.
a3) in response to a trigger on an information cleaning control, an information cleaning list including key information in the first key information set may be generated, and the information cleaning list may be submitted to an information review platform, where the information cleaning control is displayed in the operation item cell of the task information entry after the first key information set is obtained.

In the embodiment, after determining the initial key information set for the information production task and obtaining the first key information set by performing deduplication filtering, the corresponding task information entry in the task list display interface may need to be updated. Specifically, the production state included in the task information entry may be changed to a state of “data loading completed”, and the number of objects included in the task information entry may be updated to the total number of the key information included in the first key information set after performing initial key information determination and the deduplication filtering for the information production task. In addition, the operation item cell may further include an information cleaning control for initiating subsequent information cleaning operations.

In the embodiment, through this step, the trigger of the presented information cleaning control may be responded to. Thus, for the information production task, the key information in the corresponding first key information set may be taken as key information to be cleaned, and an information cleaning list including each piece of key information to be cleaned may be formed.

The information cleaning list may be submitted to the information review platform. The information review platform may be considered as an assistance platform that cooperates with the operable platform performing the method provided in the embodiment to implement information management. The information review platform may receive the information cleaning list submitted in this step, and construct a cleaning queue for the information cleaning list. The cleaning queue includes all the key information to be cleaned related to the information production task.

In a specific implementation of information cleaning at the information review platform side, the cleaning queue may be issued as a cleaning task to an operation terminal of a reviewer, such that the reviewer may perform cleaning review on each piece of key information to be cleaned in the cleaning queue.

For example, the key information to be cleaned by the reviewer may be displayed in sequence in the information cleaning operation interface according to their order in the cleaning queue. Attribute information of the key information to be cleaned for all data attribute items may be displayed in the information cleaning operation interface, and product object material for assisting the reviewer to perform information cleaning may also be displayed in the information cleaning operation interface. The product object material may include product object qualification certificates, and different types of product objects have different qualification certificates. For example, the qualification certificate for book-type product objects may be a copyright page, the qualification certificate for cosmetics-type product objects may be inspection data and usage instructions provided by the Food and Drug Administration, and the qualification certificate for electronic product-type product objects may be the 3C certificate, etc. In addition, the product object material for information cleaning may further include information about same-cluster commodities associated with the key information to be cleaned in the object cluster.

At the information review platform side, after the key information to be cleaned passes the cleaning review through the product object material and other cleaning reference items provided on the information cleaning operation interface, an information cleaning result may be generated. By triggering a submission control on the information cleaning operation interface, the information cleaning result may be cached in a cleaned information list corresponding to the information cleaning list. In addition, after completing the cleaning of all information to be cleaned in the information cleaning list, the information review platform side may feed back the corresponding generated cleaned information list to an execution platform side of the method provided in the embodiment.

FIG. 2c shows an interface display diagram of an information cleaning operation interface presented displayed on the information review platform side when performing information cleaning in the method provided in the embodiment. As shown in FIG. 2c, the displayed information cleaning operation interface 23 includes a key information display area 231 for the key information to be cleaned, a material information display area 232 for the product object material on which information cleaning depends, and a similar object information display area 233 for similar object on which information cleaning depends, and further includes a result reporting item 234 for filling in the information cleaning review result and a submission control 235 for submitting the information cleaning review. The reviewer of the information review platform may complete cleaning of the displayed information to be cleaned in the information cleaning operation interface 23. In addition, the information cleaning review result after completing the cleaning of the displayed information to be cleaned may be cached in the cleaned information list, and data content relevant to next key information to be cleaned may be re-displayed in the information cleaning operation interface 23.
b3) a cleaned information list corresponding to the information cleaning list may be received from the information review platform, and a second key information set of the information production task may be determined based on an information cleaning review result in the cleaned information list.

In the embodiment, through this step, the cleaned information list fed back by the information review platform with respect to the information cleaning list may be received. The cleaned information list includes the information cleaning review result for the key information to be cleaned in the information cleaning list. The key information to be cleaned is from the first key information set, therefore, the cleaned information list includes information cleaning review results of each piece of key information in the first key information set.

In the embodiment, based on the information cleaning review results of each piece of key information in the first key information set, it may be determined which key information has passed the information cleaning review and which has not. Then, the second key information set of the information production task may be formed based on the key information that passes the information cleaning review.
c3) in response to a trigger on an information quality inspection control, an information quality inspection list including information cleaning review results in the second key information set may be generated, and the information quality inspection list may be submitted to the information review platform, where the information quality inspection control is displayed in the operation item cell after the cleaned information list is received.

In the embodiment, it may also be known that after the second key information set is obtained by performing information cleaning for the first key information set corresponding to the information production task, the corresponding task information entry in the task list display interface may be updated. Specifically, the production state included in the task information entry may be rechanged to a state of “information cleaning completed”, and the number of objects included in the task information entry may be updated to the total number of the key information included in the second key information set obtained after information cleaning for the information production task. At the same time, the operation item cell may further include an information quality inspection control for initiating subsequent information quality inspection operations. The information quality inspection control may be displayed in the operation item cell after the cleaned information list is received.

In the embodiment, through this step, the trigger of the displayed information quality inspection control may be responded to. Thus, for the information production task, the key information in the corresponding second key information set may be taken as key information to be inspected, and an information quality inspection list including each piece of key information to be inspected may be formed.

The information quality inspection list may be submitted to the information review platform. The information review platform may receive the information quality inspection list submitted in this step, and construct a quality inspection queue for the information quality inspection list. The quality inspection queue includes all the key information to be inspected relevant to the information production task. In a specific implementation of information quality inspection on the information review platform side, the quality inspection queue may be issued as a quality inspection task to an operation terminal of a quality inspection reviewer who is different from the data cleaning reviewer, such that the quality inspection reviewer may perform quality inspection review on each piece of key information to be inspected in the quality inspection queue.

For example, the key information to be inspected by the quality inspection reviewer may be displayed in sequence in the information quality inspection operation interface according to their order in the quality inspection queue. It should be noted that in the embodiment, the information quality inspection for the key information may be considered as the second round of information cleaning for the key information, except that the quality inspection reviewer participating in the information quality inspection is different from the reviewer participating in the information cleaning, and the quality inspection reviewer may be more experienced professionals.

It may be known that data information displayed in the information quality inspection operation interface may be the same as that displayed in the information cleaning stage. The information cleaning operation interface may further include attribute information of the key information to be inspected for all data attribute items, and the product object material for assisting the quality inspection reviewer in information quality inspection. Specifically, the product object material included may further include commodity qualification certificates and data information of similar objects, etc.

At the information review platform side, similarly, after the key information to be inspected passes quality inspection review through the product object material and other quality inspection reference items provided on the information quality inspection operation interface, an information quality inspection result may be generated. By triggering a submission control in the information quality inspection operation interface, the information quality inspection result may be cached in a quality-inspected information list corresponding to the information quality inspection list. In addition, after completing the quality inspection of all information to be inspected in the information quality inspection list, the information review platform side may feed back the correspondingly formed quality-inspected information list to the execution platform side of the method provided in the embodiment.
d3) a cleaned quality inspection list corresponding to the information quality inspection list may be received from the information review platform, and a third key information set of the information production task may be determined based on quality-inspected key information in the quality-inspected information list.

In the embodiment, through this step, the quality-inspected information list fed back by the information review platform with respect to the information quality inspection list may be received. The quality-inspected information list includes the information quality inspection review result for the key information to be inspected in the information quality inspection list. The key information to be inspected may be from the second key information set, therefore, the quality-inspected information list includes information quality inspection review results of each piece of key information in the second key information set.

In the embodiment, based on the information quality inspection review results of each piece of key information in the second key information set, it may be determined which key information has passed the information quality inspection review and which has not. Then, the third key information set of the information production task may be formed based on the key information that passes the information quality inspection review.

According to the above technical solutions of the third optional embodiment of the embodiment, the specific implementation of further data cleaning processing and information quality inspection processing for the key information involved in the information production task is provided. After the key information is processed by the method provided in the third optional embodiment, the effectiveness of the produced key information may be better ensured, and the accuracy of the key information may be better improved.

As a fourth optional embodiment of the embodiment, on the basis of the above third optional embodiment, optimization steps of the method may be further added.

By processing the key information based on the method provided in the above third optional embodiment, highly accurate key information may be formed for the information production task. In principle, the highly accurate key information may be directly stored in the database. However, it should be noted that the information cleaning and information quality inspection stages further include operations for correcting data information of the reviewed key information. That is, the corrected key information may be formed by more accurately correcting the data information of the key information based on the provided product object material and similar object data information, and fed back to the execution platform side of the method provided in the embodiment, and the corrected key information may replace the existing key information in the key information set.

Based on the above description, the first key information set formed by performing storage filtering on the initial key information set may merely ensure that the key information in the first key information set does not exist in the key information database. Then, after the key information in the first key information set is further corrected through the above information cleaning and information quality inspection, it may not be guaranteed that the key information in the formed third key information set will not overlap with the data information of the stored key information in the key information database. Therefore, in the fourth optional embodiment, an operation item cell may be further optimized to display a data storage control after the third key information set is obtained. In the fourth optional embodiment, the method may also implement the storage operation of the key information through the following steps.
a4) in response to a trigger on the data storage control, storage filtering may be performed on the third key information set.

In the embodiment, after the third key information set is obtained by performing the information quality inspection on the second key information set of the information production task, the corresponding task information entry in the task list display interface may be updated. Specifically, the production state included in the task information entry may be changed to a state of “information quality inspection completed”, and the number of objects included in the task information entry may be updated to the total number of the key information included in the third key information set formed after performing the information quality inspection on the information production task. At the same time, the operation item cell may further include a data storage control for initiating subsequent data entry operations, which may be displayed in the operation item cell after the third key information set is obtained.

In the embodiment, through this step, the trigger of the displayed data storage control may be responded to. Thus, for the information production task, storage processing may be performed on the key information in the corresponding third key information set. In some embodiments, before the key information in the third key information set is stored in the database, the storage filtering may be performed on the third key information set through this step. An implementation of the storage filtering may include follows. The key information in the third key information set may be compared with the stored key information in the key information database, and it is determined whether there is any key information in the third key information set that is the same as the stored key information.
b4) key information already stored in the key information database may be recorded as second key information, and key information not stored in the key information database may be recorded as third key information, and the third key information may be added to the key information database.

In the embodiment, after the storage filtering is performed through the above step, it may be determined whether the third key information set includes the key information already stored in the key information database. If it is determined that the third key information set includes the key information already stored in the key information database, through this step, such key information may be recorded as the second key information. Moreover, the key information in the third key information set not stored in the key information database may be recorded as the third key information, and the operation of adding the third key information to the key information database may be completed.

It may be known that after completing the storage operation of the third key information corresponding to the information production task to the key information database, the production state in the task information entry may be updated to a state of “data storage completed”, and the object data included in the task information entry may be updated to the total number of key information of the third key information participating in data storage.

According to the above technical solutions of the fourth optional embodiment of the embodiment, the implementation of storing the key information to be stored corresponding to the information production task and the filtering of the key information to be stored before storage are provided. With the technical solutions provided in the embodiment, the accuracy and uniqueness of the key information stored in the key information database may be ensured. The above technical solutions may better realize effective large-scale production of key information.

As a fifth optional embodiment of the embodiment, on the basis of the above fourth optional embodiment, the embodiment further considers an implementation logic for establishing an association relationship between the key information involved in the information production task and e-commerce commodities.

It should be noted that, in the embodiment, for the key information produced for the information production task, one of the main application scenarios is to provide unified product object description information for the product object on e-commerce platforms. To achieve this goal, a prerequisite is to establish an association relationship between the key information and the product object on the e-commerce platform. Regarding the establishment of the association relationship between the key information and the product object, an implementation is to directly create an association relationship task through a key relationship task creation control included on the execution platform of the method provided in the embodiment. In this way of directly creating the association relationship task, data relied for task execution may include object data to be associated and determined key information. Moreover, the created association relationship task may be displayed in an association task list display interface, and by triggering an operation control relevant to the created association relationship task, the association relationship between the provided object data and the provided determined key information may be established.

Continuing with the above description, a further implementation of establishing the association relationship between the key information and the product object may be that in the configuration for creating the information production task, the execution configuration for establishing the association relationship is directly performed in the configuration operation area of whether to establish the association relationship. Therefore, in the embodiment, after completing the processing of the key information corresponding to the information production task, a task relevant to the establishment of the corresponding association relationship may be automatically generated for the information production task, and the establishment of the direct association relationship between the key information involved in the information production task and the corresponding product object may be realized.

Specifically, in order to realize the logic of establishing the direct association relationship between the key information involved in the information production task and the corresponding product object, the method provided in the embodiment further includes the following steps.
a5) the determined first key information, the second key information and/or the third key information may be regarded as valid key information of the information production task, and object clusters in the clustering result corresponding to the first key information, the second key information and/or the third key information may be recorded as valid object clusters respectively.

In the embodiment, during entire data processing stage of the information production task, if there are corresponding first key information, the second key information and the third key information, then the first key information, the second key information and the third key information may all be recorded as the valid key information of the information production task. It may be understood that the first key information may be the stored key information already stored in the key information database in the initial key information set, the second key information may be the stored key information already stored in the key information database in the third key information set, and the third key information may be the stored key information added to the key information database in the final storage stage. The above key information may be considered as the valid key information relevant to the information production task.

In the embodiment, whether it is the first key information, the second key information or the third key information, all of them may be regarded as key information obtained after previous clustering processing. Thus, the first key information, the second key information and the third key information may correspond to its own object clusters in the clustering result. In this step, the object clusters in the clustering result corresponding to the first key information, the second key information and/or the third key information may be recorded as the valid object clusters respectively.
b5) if the information production task is configured with the association relationship in a creation stage, an associated subtask of the information production task may be generated, where the associated subtask may be configured to establish an association relationship between the valid key information and intra-cluster object data in the corresponding valid object cluster.

In the embodiment, as long as the information production task is configured to execute the association relationship in the creation stage, the associated subtask of the information production task may be generated through this step, and the associated subtask may also be displayed in the association task list display interface. By triggering the associated subtask, the association relationship between the valid key information and the intra-cluster object data in the corresponding valid object cluster may be established.

It may also be known that if the information production task is not configured to execute the association relationship in the creation stage, in the embodiment, a corresponding subtask for establishing the association relationship will not be automatically generated for the information production task. In this case, the creation logic of the association task is required to manually complete the establishment of the associated subtask.

According to the above technical solutions of the fifth optional embodiment of the embodiment, the task establishment implementation of the associated subtask involved in the information production task is given. The above solution provided in the embodiment is equivalent to providing an implementation way of establishing the association relationship between the key information and the product in the e-commerce platform, and the technical solution may effectively solve the problem that the existing method cannot realize the establishment of the direct association relationship between the key information and the product object on a large scale. A simple and effective operation channel is provided for the association mounting of the key information and the product object.

Continuing with the above description, on the basis of the above optimizations, the method may be further optimized to include the following steps.
a6) in response to an execution trigger on the associated subtask, it is determined whether the valid key information satisfies a review-free establishment condition for the association relationship, and if yes, step b6) is performed; if not, step c6) is performed.

In the embodiment, as long as the established associated subtask is triggered, the execution trigger of the associated subtask may be responded to through this step. In the embodiment, the association relationship between the key information and the product object also needs to be reviewed by the information review platform, but for the associated subtask that satisfies the review-free establishment condition for the association relationship, the association relationship between the corresponding valid key information and the corresponding object data may be directly established.

The review-free establishment condition includes that: the valid object cluster corresponding to the valid key information includes a piece of intra-cluster object data; or it is detected that an intra-cluster accuracy of the intra-cluster object data in the valid object cluster corresponding to the valid key information reaches a configured accuracy threshold.

Specifically, the case that the valid object cluster corresponding to the valid key information includes only one piece of intra-cluster object data may be considered as the case that there is an orphan object (that is, there is only one such product object). In addition, on the premise that the clustering accuracy is ensured in the clustering processing process, the association relationship between the valid key information obtained under high-precision clustering and the intra-cluster object data in the valid object cluster may also be established without review. In some embodiments, the high-precision clustering may be considered that the same-cluster accuracy determined for the intra-cluster object data in the valid object cluster reaches the configured accuracy threshold.

In the embodiment, when the review-free establishment condition is satisfied, the operation of step b6) may be executed, and when the review-free establishment condition is not met, the operation of step c6) may be executed.
b6) association mounting information may be determined by directly establishing the association relationship between the valid key information and the intra-cluster object data in the corresponding valid object cluster.

In the embodiment, when the review-free establishment condition is satisfied, the association relationship between the valid key information and the intra-cluster object data in the corresponding valid object cluster may be directly established through this step, so that the valid key information is associated with each piece of the intra-cluster object data in the valid object cluster respectively, and the association mounting information between the valid key information and the associated intra-cluster object data is formed.
c6) an association relationship review may be performed on the valid key information, and the association mounting information may be determined by establishing the association relationship between the valid key information and the intra-cluster object data satisfying a review condition in the corresponding valid object cluster.

In the embodiment, when the review-free establishment condition is not satisfied, the association relationship review may be performed on the valid key information through this step, and after the association relationship between the valid key information and the intra-cluster object data that satisfies the review condition in the corresponding valid object cluster is established, the valid key information may be associated with the intra-cluster object data that passes the review, and the association mounting information between the valid key information and the associated intra-cluster object data may be thus formed.
d6) the association mounting information may be added to an association mounting database.

In the embodiment, after completing the determination of the above association mounting information, through this step, each formed association mounting information may be added to the association mounting database for storage.

According to the above technical solutions of the fifth optional embodiment of the embodiment, the implementation of establishing the association relationship between the key information and different product objects is provided. In this way, the success rate of association relationship mounting between the key information and the product object may be greatly improved, and time cost and resource cost may also be better saved.

On the basis of the above fifth optional embodiment, the association relationship review on the valid key information and the determination of association mounting information by establishing the association relationship between the valid key information and the intra-cluster object data that satisfies the review condition in the corresponding valid object cluster may be specifically optimized as the following steps.
c51) an association relationship review list of the valid key information may be generated, the association relationship review list including the intra-cluster object data in the valid object cluster corresponding to the valid key information.

In the embodiment, for the valid key information that requires review and the intra-cluster object data in the corresponding valid object cluster, the association relationship review list for association relationship review may be generated through this step.
c52) the association relationship review list may be submitted to the information review platform, and receiving an association relationship review result corresponding to the association relationship review list may be received from the information review platform, the association relationship review result including a review result of the valid key information and corresponding intra-cluster object data.

In the embodiment, the association relationship review list may be submitted to the information review platform, and the association relationship reviewer on the information review platform side may review the association relationship between the valid key information in the management relationship review list and the intra-cluster object data in the corresponding valid object cluster through a corresponding operation terminal.

Continuing with the above description, the association relationship reviewer may also submit and cache the association relationship review result in an association relationship review result table. The association relationship review result table may include the review result of the association relationship between each valid key information and relevant intra-cluster object data. In this step, the association relationship review result table may be fed back to the execution platform of the method provided in the embodiment, so as to obtain the review result of the valid key information and the corresponding intra-cluster object data.
c53) the association mounting information may be determined by establishing the association relationship between the valid key information and the intra-cluster object data with the review result of approved.

In the embodiment, the review result of the valid key information and the corresponding intra-cluster object data may be “approved” or “not approved”. In this step, the association relationship between the valid key information and the intra-cluster object data with the review result of “approved” may be established, so as to form the association mounting information.

According to the above technical solutions of the embodiment, an implementation manner for reviewing the association relationship to be reviewed is provided. Specifically, it obtains the review result with the assistance of the information review platform, and establishes the association relationship between the valid key information that passes the review and the intra-cluster object data. This implementation may better ensure the accuracy of the formed association mounting information.

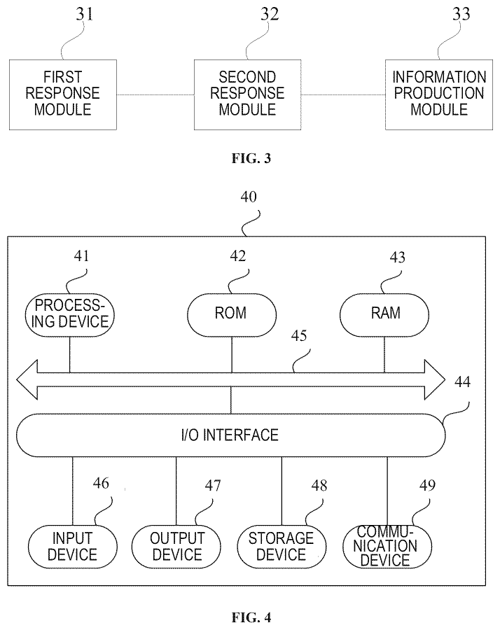

FIG. 3 is a schematic structural diagram of an apparatus for managing information of an object provided by an embodiment of the present disclosure. The embodiment may be applied to the scenario of managing key information involved in a product object. The apparatus may be implemented by software and/or hardware, and may be configured in a terminal and/or a server to implement the method for managing information of an object according to the embodiment of the present disclosure. The apparatus may include a first response module 31, a second response module 32, and an information production module 33.

The first response module 31 is configured to display, in a task list display interface, a task creation entry of an information production task in response to a creation submission request for creating the information production task. An operation item cell included in the task creation entry includes a loading control for task data loading.

The second response module 32 is configured to load, in response to a trigger on the loading control, a relevant object dataset based on data source information corresponding to the information production task.

The information production module 33 is configured to perform clustering processing on object data in the object dataset, and generate an initial key information set corresponding to the information production task based on a clustering result of the clustering processing.

With the apparatus for managing information of an object provided in the embodiment, when there is a need for key information production, the information production task may be first created, and task information of the created information production task may be displayed, in the task list display interface, in a form of entries. The displayed task information entry may correspond to the operation item cell, which may include an operation control that triggers the information production task to respond to relevant execution logic. After responding to the trigger of the loading control corresponding to the information production task, the information production logic of the information production task may be executed, and finally the initial key information set corresponding to the information production task may be obtained. With the above technical solutions of the embodiment, the key information set corresponding to the information production task may be simply and effectively generated by only simply creating the information production task, and the key information set may include a certain scale of key information. Compared with the prior art, the technical solution may provide a production way for large-scale information production, which may simply and efficiently achieve large-scale generation of key information of product objects. It may better save manpower and time cost input in the production stage of key information of product objects, and better improve the production efficiency of key information of product objects.

Further, the information production module 33 may further include a clustering processing unit, and an information production unit.

The clustering processing unit is configured to obtain the clustering result corresponding to the information production task by performing clustering processing on the object data in the object dataset using a predetermined object similarity-matching model. The clustering result includes at least one object cluster, an object cluster includes intra-cluster object data, and the intra-cluster object data shares a same configured attribute in the object dataset.

The information production unit is configured to generate the initial key information set corresponding to the information production task based on respective object clusters.

Further, the clustering processing unit may further include an object selecting subunit, a similarity-matching subunit, and a clustering processing subunit.

The object selecting subunit is configured to select a plurality of pieces of object data from the object dataset as reference object data for similarity-matching.

The similarity-matching subunit is configured to determine, based on the predetermined object similarity-matching model, similar object data in the object dataset matching the reference object data, and obtain a plurality of similar object datasets each comprising the reference object data and corresponding similar object data.

The clustering processing subunit is configured to determine the clustering result corresponding to the information production task based on the plurality of similar object datasets.

Further, the clustering processing subunit may be further configured to: determine an object overlap degree between two similar object datasets in the plurality of similar object datasets, and obtain a new similar object dataset by merging the two similar object datasets in response to the object overlap degree satisfying a merging condition; repeat operations of determining the object overlap degree and merging the two similar object datasets until a number of the new similar object datasets remains unchanged; and obtain, for the information production task, the clustering result comprising respective object clusters by using a similar object dataset obtained from the operations as an object cluster, where the similar object data included in the object cluster is recorded as the intra-cluster object data.

Further, the information production unit may be further configured to: obtain, for an object cluster of the clustering result, the intra-cluster object data included in the object cluster; determine a key attribute value of a data attribute item based on attribute values of respective data attribute items included in the intra-cluster object data; and determine the initial key information of the object cluster based on respective key attribute values, and determine the initial key information set corresponding to the information production task based on the initial key information of respective object clusters.

Furthermore, the apparatus may further include a first filtering module, and a first result generation module.

The first filtering module is configured to access a pre-built key information database and record, in the initial key information set, initial key information already stored in the key information database as the first key information.

The first result generation module is configured to obtain a first key information set of the information production task based on remaining initial key information after filtering out the first key information.

Furthermore, the apparatus may further include a third response module, a second result generation module, a fourth response module, and a third result generation module.

The third response module is configured to generate, in response to a trigger on an information cleaning control, an information cleaning list including key information in the first key information set, and submit the information cleaning list to an information review platform, the information cleaning control being displayed in the operation item cell of the task creation entry after the first key information set is obtained.

The second result generation module is configured to receive, from the information review platform, a cleaned information list corresponding to the information cleaning list, and determine a second key information set of the information production task based on an information cleaning review result in the cleaned information list.

The fourth response module is configured to generate, in response to a trigger on an information quality inspection control, an information quality inspection list including the information cleaning review result in the second key information set, and submit the information quality inspection list to the information review platform, the information quality inspection control being displayed in the operation item cell after the cleaned information list is received.

The third result generation module is configured to receive, from the information review platform, a cleaned quality inspection list corresponding to the information quality inspection list, and determine a third key information set of the information production task based on quality-inspected key information in the quality-inspected information list.

Further, the operation item cell may present a data storage control after the third key information set is obtained, and accordingly, the apparatus may further include a second filtering module, and a standard product storage module.

The second filtering module is configured to perform, in response to a trigger on the data storage control, storage filtering on the third key information set.

The standard product storage module is configured to record key information already stored in the key information database as second key information, record key information not existing in the key information database as third key information, and add the third key information to the key information database.

Furthermore, the apparatus may further include a standard product determination module, and a task establishment module.

The standard product determination module is configured to regard the first key information, the second key information and/or the third key information as valid key information of the information production task, and record object clusters in the clustering result respectively corresponding to the first key information, the second key information and/or the third key information as valid object clusters.

The task establishment module is configured to generate, in response to configuring an association relationship for the information production task in a creation stage, an associated subtask of the information production task, the associated subtask being configured to establish an association relationship between the valid key information and intra-cluster object data in the corresponding valid object cluster.

Furthermore, the apparatus may further include a fifth response module, a first execution module, a second execution module, and an association storage module.

The fifth response module is configured to determine, in response to an execution trigger on the associated subtask, whether the valid key information satisfies an review-free establishment condition for the association relationship.

The first execution module is configured to determine, in response to the valid key information satisfying the review-free establishment condition, association mounting information by directly establishing the association relationship between the valid key information and the intra-cluster object data in the corresponding valid object cluster.

The second execution module is configured to perform, in response to the valid key information not satisfying the review-free establishment condition, an association relationship review on the valid key information, and determine the association mounting information by establishing the association relationship between the valid key information and intra-cluster object data satisfying a review condition in the corresponding valid object cluster.

The association storage module is configured to add the association mounting information to an association mounting database.

Further, the review-free establishment condition includes the valid object cluster corresponding to the valid key information including a piece of intra-cluster object data, or an intra-cluster accuracy of the intra-cluster object data in the valid object cluster corresponding to the valid key information reaching a configured accuracy threshold.

Further, the second execution module may be further configured to: generate an association relationship review list of the valid key information, the association relationship review list including the intra-cluster object data in the valid object cluster corresponding to the valid key information; submit the association relationship review list to the information review platform, and receive, from the information review platform, an association relationship review result corresponding to the association relationship review list, the association relationship review result comprising a review result of the valid key information and the corresponding intra-cluster object data; and determine the association mounting information by establishing the association relationship between the valid key information and intra-cluster object data with the review result being approved.

The above apparatus may execute the method provided by any embodiment of the present disclosure, and has corresponding functional modules and beneficial effects for executing the method.

It is worth noting that the units and modules included in the above apparatus are only divided according to functional logic, but are not limited to the above division, as long as the corresponding functions may be realized. In addition, the specific names of the functional units are only for the convenience of distinguishing from each other, and are not used to limit the protection scope of the embodiments of the present disclosure.

FIG. 4 is a schematic structural diagram of a computer device provided by an embodiment of the present disclosure. Reference is made to FIG. 4 below, which illustrates a schematic structural diagram of a computer device 40 (such as a terminal device or a server in FIG. 4) suitable for implementing the embodiments of the present disclosure. The terminal device in the embodiments of the present disclosure may include, but is not limited to, mobile terminals such as a mobile phone, a notebook computer, a digital broadcast receiver, a personal digital assistant (PDA), a tablet computer, a portable media player (PMP), a vehicle-mounted terminal (such as a vehicle navigation terminal), etc., and fixed terminals such as a digital TV, a desktop computer, etc. The computer device shown in FIG. 4 is only an example, and should not impose any limitation over the function and scope of use of the embodiments of the present disclosure.

As shown in FIG. 4, the computer device 40 may include a processing device (such as a central processing unit, a graphics processor, etc.) 41, which may perform various appropriate actions and processing according to a program stored in a read-only memory (ROM) 42 or a program loaded from a storage device 48 into a random access memory (RAM) 43. The RAM 43 further stores various programs and data required for operations of the computer device 40. The processing device 41, the ROM 42, and the RAM 43 are interconnected by means of a bus 45. An editing/output (I/O) interface 44 is also connected to the bus 45.

Usually, the following devices may be connected to the I/O interface 44: an input device 46 including, for example, a touch screen, a touchpad, a keyboard, a mouse, a camera, a microphone, an accelerometer, a gyroscope, etc.; an output device 47 including, for example, a liquid crystal display (LCD), a speaker, a vibrator, etc.; a storage device 48 including, for example, a magnetic tape, a hard disk, etc.; and a communication device 49. The communication device 49 may allow the computer device 40 to perform wireless or wired communication with other devices to exchange data. Although FIG. 4 shows the computer device 40 having various devices, it should be understood that it is not required to implement or have all of the devices shown. More or fewer devices may be implemented or provided alternatively.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, the computer program containing program code for executing the method shown in the flowchart. In such an embodiment, the computer program may be downloaded and installed from a network through the communication device 49, or installed from the storage device 48, or installed from the ROM 42. When the computer program is executed by the processing device 41, the above-mentioned functions defined in the method of the embodiment of the present disclosure are executed.

The names of messages or information exchanged between multiple devices in the implementations of the present disclosure are only used for illustrative purposes, and are not used to limit the scope of these messages or information.

The computer device provided in the embodiment of the present disclosure belongs to a same inventive concept as the method for managing information of an object provided by the above embodiment. For technical details not described in detail in the embodiment, reference may be made to the above embodiment, and the embodiment has the same beneficial effects as the above embodiment.

An embodiment of the present disclosure provides a computer storage medium having a computer program stored thereon, the program, when executed by a processor, implements the method for managing information of an object provided by the above embodiment.

It should be noted that the above computer-readable medium in the present disclosure may be a computer-readable signal medium, a computer-readable storage medium, or any combination of the two. The computer-readable storage medium may be, for example, but not limited to, an electrical, magnetic, optical, electromagnetic, infrared, or semi-conductive system, apparatus or device, or any combination of the above. More specific examples of the computer-readable storage medium may include, but are not limited to: an electrically connected portable computer disk with one or more wires, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

In the present disclosure, the computer-readable storage medium may be any tangible medium that includes or stores a program, which may be used by or in combination with an instruction execution system, apparatus, or device. In the present disclosure, the computer-readable signal medium may include a data signal propagated on a baseband or as a part of a carrier, and computer-readable program code is carried therein. This propagated data signal may be in multiple forms, including but not limited to, an electromagnetic signal, an optical signal, or any suitable combination of the above. The computer-readable signal medium may also be any computer-readable medium other than the computer-readable storage medium, and the computer-readable signal medium may send, propagate, or transmit the program used by or in combination with the instruction execution system, apparatus, or device. The program code contained on the computer-readable medium may be transmitted by any suitable medium, including but not limited to: a wire, an optical cable, a radio frequency (RF), etc., or any suitable combination of the above.

In some implementations, the client and the server may communicate using any currently known or future developed network protocol, such as the hypertext transfer protocol (HTTP), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The above computer-readable medium may be included in the above computer device, or it may exist alone without being assembled into the computer device.

The above computer-readable medium carries one or more programs, and when the one or more programs are executed by the computer device, the computer device is caused to perform operations.

The computer program code for performing the operations of the present disclosure may be written in one or more programming languages or a combination thereof, the above programming languages including but not limited to object-oriented programming languages such as Java, Smalltalk, C++, and conventional procedural programming languages such as “C” language or similar programming languages. The program code may be completely executed on a computer of a user, partially executed on a computer of a user, executed as an independent software package, partially executed on a computer of a user and partially executed on a remote computer, or completely executed on a remote computer or a server. In the case of involving the remote computer, the remote computer may be connected to the computer of the user through any kind of network, including a local area network (LAN) or a wide area network (WAN), or it may be connected to an external computer (for example, connected by using Internet provided by an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which includes one or more executable instructions for implementing the specified logical function. It should also be noted that, in some alternative implementations, the functions marked in the block may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units involved in the embodiments of the present disclosure may be implemented in a form of software, and may also be implemented in a form of hardware. In some embodiments, the name of a unit does not constitute a limitation on the unit itself under certain circumstances, for example, the first acquisition unit may also be described as “a unit for obtain at least two internet protocol addresses”.

The functions described above may be performed at least partially by one or more hardware logic components. For example, without limitation, various types of the hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semi-conductive system, apparatus, or device, or any suitable combination of the above. More specific examples of the machine-readable storage medium may include: an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

The above description is only preferred embodiments of the present disclosure and an explanation of the technical principles employed. Those skilled in the art should understand that the disclosure scope involved in the present disclosure is not limited to the technical solutions formed by the specific combination of the above technical features, and should also cover other technical solutions formed by any combination of the above technical features or their equivalent features without departing from the above disclosure concept. For example, the above features and the technical features disclosed in the present disclosure (but not limited to) with similar functions may be mutually replaced to form a technical solution.

Furthermore, although the various operations are depicted in a particular order, it should not be understood as requiring these operations to be performed in the particular order shown or in a sequential order. Under certain circumstances, multitasking and parallel processing may be advantageous. Likewise, although the above discussion contains a number of specific implementation details, these should not be interpreted as limiting the scope of the present disclosure. Certain features described in the context of separate embodiments may also be implemented in a single embodiment in combination. On the contrary, various features described in the context of a single embodiment may also be implemented in multiple embodiments individually or in any suitable sub-combination.

Although the subject matter has been described in a language specific to structural features and/or logical actions of the method, it should be understood that the subject matter defined in the appended claims is not necessarily limited to the specific features or actions described above. On the contrary, the specific features and actions described above are only illustrative forms for implementing the claims.

1. A method for managing information of an object, comprising:
displaying, in a task list display interface, a task creation entry of an information production task in response to a creation submission request for creating the information production task, an operation item cell comprised in the task creation entry comprising a loading control for task data loading;
loading, in response to a trigger on the loading control, a relevant object dataset based on data source information corresponding to the information production task; and
performing clustering processing on object data in the object dataset, and generating an initial key information set corresponding to the information production task based on a clustering result of the clustering processing.

2. The method of claim 1, wherein performing clustering processing on the object data in the object dataset, and generating the initial key information set corresponding to the information production task based on the clustering result of the clustering processing comprises:
obtaining the clustering result corresponding to the information production task by performing clustering processing on the object data in the object dataset using a predetermined object similarity-matching model, the clustering result comprising at least one object cluster, an object cluster comprising intra-cluster object data, and the intra-cluster object data sharing a same configured attribute in the object dataset; and
generating the initial key information set corresponding to the information production task based on respective object clusters.

3. The method of claim 2, wherein obtaining the clustering result corresponding to the information production task by performing clustering processing on the object data in the object dataset using the predetermined object similarity-matching model comprises:
selecting a plurality of pieces of object data from the object dataset as reference object data for similarity-matching;
determining, based on the predetermined object similarity-matching model, similar object data in the object dataset matching the reference object data, and obtaining a plurality of similar object datasets each comprising the reference object data and corresponding similar object data; and
determining the clustering result corresponding to the information production task based on the plurality of similar object datasets.

4. The method of claim 3, wherein determining the clustering result corresponding to the information production task based on the plurality of similar object datasets comprises:
determining an object overlap degree between two similar object datasets in the plurality of similar object datasets, and obtaining a new similar object dataset by merging the two similar object datasets in response to the object overlap degree satisfying a merging condition;
repeating operations of determining the object overlap degree and merging the two similar object datasets until a number of the new similar object datasets remains unchanged; and
obtaining, for the information production task, the clustering result comprising respective object clusters by using a similar object dataset obtained from the operations as an object cluster, wherein the similar object data comprised in the object cluster is recorded as the intra-cluster object data.

5. The method of claim 2, wherein generating the initial key information set corresponding to the information production task based on respective object clusters comprises:
obtaining, for an object cluster in the clustering result, the intra-cluster object data comprised in the object cluster;
determining a key attribute value of a data attribute item based on attribute values of respective data attribute items comprised in the intra-cluster object data; and
determining the initial key information of the object cluster based on respective key attribute values, and determining the initial key information set corresponding to the information production task based on the initial key information of respective object clusters.

6. The method of claim 1, further comprising:
accessing a pre-built key information database, and recording, in the initial key information set, initial key information already stored in the key information database as first key information; and
obtaining a first key information set of the information production task based on remaining initial key information after filtering out the first key information.

7. The method of claim 6, further comprising:
generating, in response to a trigger on an information cleaning control, an information cleaning list comprising key information in the first key information set, and submitting the information cleaning list to an information review platform, the information cleaning control being displayed in the operation item cell of the task creation entry after the first key information set is obtained;
receiving, from the information review platform, a cleaned information list corresponding to the information cleaning list, and determining a second key information set of the information production task based on an information cleaning review result in the cleaned information list;
generating, in response to a trigger on an information quality inspection control, an information quality inspection list comprising the information cleaning review result in the second key information set, and submitting the information quality inspection list to the information review platform, the information quality inspection control being displayed in the operation item cell after the cleaned information list is received; and
receiving, from the information review platform, a cleaned quality inspection list corresponding to the information quality inspection list, and determining a third key information set of the information production task based on quality-inspected key information in the quality-inspected information list.

8. The method of claim 7, wherein the operation item cell presents a data storage control after the third key information set is obtained, and the method further comprises:
performing, in response to a trigger on the data storage control, storage filtering on the third key information set; and
recording key information already stored in the key information database as second key information, recording key information not stored in the key information database as third key information, and adding the third key information to the key information database.

9. The method of claim 8, further comprising:
regarding the first key information, the second key information and/or the third key information as valid key information of the information production task, and recording object clusters in the clustering result respectively corresponding to the first key information, the second key information and/or the third key information as valid object clusters; and
generating, in response to configuring an association relationship for the information production task in a creation stage, an associated subtask of the information production task, the associated subtask being configured to establish an association relationship between the valid key information and intra-cluster object data in the corresponding valid object cluster.

10. The method of claim 9, further comprising:
determining, in response to an execution trigger on the associated subtask, whether the valid key information satisfies a review-free establishment condition for the association relationship;
determining, in response to the valid key information satisfying the review-free establishment condition, association mounting information by directly establishing the association relationship between the valid key information and the intra-cluster object data in the corresponding valid object cluster;
performing, in response to the valid key information not satisfying the review-free establishment condition, an association relationship review on the valid key information, and determining the association mounting information by establishing the association relationship between the valid key information and intra-cluster object data satisfying a review condition in the corresponding valid object cluster; and
adding the association mounting information to an association mounting database.

11. The method of claim 10, wherein the review-free establishment condition comprises:
the valid object cluster corresponding to the valid key information comprising a piece of intra-cluster object data; or
an intra-cluster accuracy of the intra-cluster object data in the valid object cluster corresponding to the valid key information reaching a configured accuracy threshold.

12. The method of claim 10, wherein performing the association relationship review on the valid key information, and forming the association mounting information by establishing the association relationship between the valid key information and intra-cluster object data satisfying the review condition in the corresponding valid object cluster comprises:
generating an association relationship review list of the valid key information, the association relationship review list comprising intra-cluster object data in the valid object cluster corresponding to the valid key information;
submitting the association relationship review list to the information review platform, and receiving, from the information review platform, an association relationship review result corresponding to the association relationship review list, the association relationship review result comprising a review result of the valid key information and the corresponding intra-cluster object data; and
determining the association mounting information by establishing the association relationship between the valid key information and intra-cluster object data with the review result of approved.

13. (canceled)

14. A computer device, comprising:
one or more processors; and a storage device configured to store one or more programs,
the one or more programs, when executed by the one or more processors, causing the one or more processors to perform operations comprising:
displaying, in a task list display interface, a task creation entry of an information production task in response to a creation submission request for creating the information production task, an operation item cell comprised in the task creation entry comprising a loading control for task data loading;
loading, in response to a trigger on the loading control, a relevant object dataset based on data source information corresponding to the information production task; and
performing clustering processing on object data in the object dataset, and generating an initial key information set corresponding to the information production task based on a clustering result of the clustering processing.

15. A non-transitory computer-readable storage medium having a computer program stored thereon, the program, when executed by a processor, performing operations comprising:
displaying, in a task list display interface, a task creation entry of an information production task in response to a creation submission request for creating the information production task, an operation item cell comprised in the task creation entry comprising a loading control for task data loading;
loading, in response to a trigger on the loading control, a relevant object dataset based on data source information corresponding to the information production task; and
performing clustering processing on object data in the object dataset, and generating an initial key information set corresponding to the information production task based on a clustering result of the clustering processing.

16. The computer device of claim 14, wherein performing clustering processing on the object data in the object dataset, and generating the initial key information set corresponding to the information production task based on the clustering result of the clustering processing comprises:
obtaining the clustering result corresponding to the information production task by performing clustering processing on the object data in the object dataset using a predetermined object similarity-matching model, the clustering result comprising at least one object cluster, an object cluster comprising intra-cluster object data, and the intra-cluster object data sharing a same configured attribute in the object dataset; and
generating the initial key information set corresponding to the information production task based on respective object clusters.

17. The computer device of claim 16, wherein obtaining the clustering result corresponding to the information production task by performing clustering processing on the object data in the object dataset using the predetermined object similarity-matching model comprises:
selecting a plurality of pieces of object data from the object dataset as reference object data for similarity-matching;
determining, based on the predetermined object similarity-matching model, similar object data in the object dataset matching the reference object data, and obtaining a plurality of similar object datasets each comprising the reference object data and corresponding similar object data; and
determining the clustering result corresponding to the information production task based on the plurality of similar object datasets.

18. The computer device of claim 17, wherein determining the clustering result corresponding to the information production task based on the plurality of similar object datasets comprises:
determining an object overlap degree between two similar object datasets in the plurality of similar object datasets, and obtaining a new similar object dataset by merging the two similar object datasets in response to the object overlap degree satisfying a merging condition;
repeating operations of determining the object overlap degree and merging the two similar object datasets until a number of the new similar object datasets remains unchanged; and
obtaining, for the information production task, the clustering result comprising respective object clusters by using a similar object dataset obtained from the operations as an object cluster, wherein the similar object data comprised in the object cluster is recorded as the intra-cluster object data.

19. The computer device of claim 16, wherein generating the initial key information set corresponding to the information production task based on respective object clusters comprises:
obtaining, for an object cluster in the clustering result, the intra-cluster object data comprised in the object cluster;
determining a key attribute value of a data attribute item based on attribute values of respective data attribute items comprised in the intra-cluster object data; and
determining the initial key information of the object cluster based on respective key attribute values, and determining the initial key information set corresponding to the information production task based on the initial key information of respective object clusters.

20. The computer device of claim 14, wherein the operations further comprise:
accessing a pre-built key information database, and recording, in the initial key information set, initial key information already stored in the key information database as first key information; and
obtaining a first key information set of the information production task based on remaining initial key information after filtering out the first key information.

21. The computer device of claim 20, wherein the operations further comprise:
generating, in response to a trigger on an information cleaning control, an information cleaning list comprising key information in the first key information set, and submitting the information cleaning list to an information review platform, the information cleaning control being displayed in the operation item cell of the task creation entry after the first key information set is obtained;
receiving, from the information review platform, a cleaned information list corresponding to the information cleaning list, and determining a second key information set of the information production task based on an information cleaning review result in the cleaned information list;
generating, in response to a trigger on an information quality inspection control, an information quality inspection list comprising the information cleaning review result in the second key information set, and submitting the information quality inspection list to the information review platform, the information quality inspection control being displayed in the operation item cell after the cleaned information list is received; and
receiving, from the information review platform, a cleaned quality inspection list corresponding to the information quality inspection list, and determining a third key information set of the information production task based on quality-inspected key information in the quality-inspected information list.
